(19) United States
(12) Patent Application Publication
(10) Pub. No.: US 2010/0120404 A1
(43) Pub. Date: May 13, 2010

(54) METHOD FOR PROVIDING TRANSLATION SERVICES

(76) Inventor: Andrzej BERNAL, Slawno (PL)

Correspondence Address: MATTHIAS SCHOLL, 14781 MEMORIAL DRIVE, SUITE 1319, HOUSTON, TX, 77079, US

(21) Appl. No.: 12/269,067

(22) Filed: Nov. 12, 2008

(51) Int. Cl. H04M 3/42

(52) U.S. Cl. 455/417

(57) ABSTRACT

A method for providing translation services between a first party and a second party, using a single telecommunication device, comprising: providing a plurality of language selection options in the telecommunication device; receiving a language selection via the telecommunication device; and connecting a telecommunication call via the single telecommunication device to a translator based on the language selection. A method for providing translation services between a call-placing party and a call-receiving party, each party having its own telecommunication device, comprising: providing a plurality of language selection options the call-placing party and the call-receiving party; receiving from the parties language selections; storing the language selections in the telecommunication devices; transmitting the language selection to a server, and storing them in a database; and upon request from the call placing party connecting a three-way telecommunication call between the call-placing party, the call-receiving party, and a translator according to data stored in the database.

### BACKGROUND OF THE INVENTION

1. Field of the Invention

The invention relates to a method for providing translation services to parties in need thereof, and more particularly to providing translation services over a telecommunication network.

2. Description of the Related Art

Businesses and private parties avail themselves to receiving telecommunication from others. A typical business or household has a plurality of telephones, fax machines, and computers with the help of which it receives communication. Some of the communication is left for the business to process after it is received (e.g., voice mail, faxes, emails); other communication is customarily dealt with in real time while it is being received (e.g., telephone calls, computer chats).

The advent of global reduction of telecommunication prices and increased mobility of people and businesses results in an increased number of telecommunication received in languages that are not spoken or understood by the receiving party. Generally, when such communication is received, it is largely discarded without being processed. This squanders resources and opportunity. While translation services are available, protocols for connecting parties with translators are often cumbersome and lack automation.

Accordingly, much opportunity for improvement is found in this area of technology.

### SUMMARY OF THE INVENTION

In one embodiment of the invention provided is a method for providing translation services between a first party and a second party, using a single telecommunication device that is shared between the parties, the method comprising the steps of: (a) providing a plurality of language selection options via the telecommunication device; (b) receiving a language selection via the telecommunication device; and (c) connecting a telecommunication call via the telecommunication device to a translator based on the language selection.

In a class of this embodiment, the first party and the second party are physically present in the same place.

In a class of this embodiment, the first party is present in a country foreign to the first party and the second party is present in a country that is native to the second party.

In a class of this embodiment, the first party speaks a first language and the second party speaks a second language.

In a subclass of this class of this embodiment, the first language and the second language are not the same.

In a class of this embodiment, the plurality of language selection options in the telecommunication device is provided to the first party.

In a class of this embodiment, the first party initiates the connection to a translator.

In a class of this embodiment, the language selection via the telecommunication device is received from the first party.

In a class of this embodiment, the first party is a client and the second party is a merchant, or vice versa.

In a class of this embodiment, the telecommunication device is owned by the first party or by the second party.

In a class of this embodiment, the first party is a person reporting an emergency and the second party is an emergency responder, or vice versa.

In a class of this embodiment, the first party is a person reporting information about terrorist activities and the second party party is a member of a counter-terrorist organization, or vice versa.

In another class of this embodiment, the providing to the first party a plurality of language selection options comprises providing spoken instructions for associating each language with one or more telecommunication device keys.

In a subclass of this class of this embodiment the spoken instructions are provided in a plurality of languages or in the first language.

In another class of this embodiment, the providing to the first party a plurality of language selection options comprises displaying language selections options on a screen of the telecommunication device.

In another class of this embodiment, displaying language selections options on a screen of the telecommunication device comprises displaying: on a first screen, a world map with the contours of continents; on a second screen, a continent map with contours of individual countries, and optionally, on a third screen, languages spoken in a country.

In another class of this embodiment, displaying language selections options on a screen of the telecommunication device comprises displaying an association between a language and a telecommunication device key, or a picture, or a sign on the screen of the telecommunication device.

In a subclass of this class of this embodiment, the language selections options are displayed in a plurality of languages or in the first language.

In another class of this embodiment, receiving a language selection from the first party via the telecommunication device comprises pressing a portion of the screen on the telecommunication device corresponding to a language selection option, or a picture, or a sign on the screen of the telecommunication device.

In another class of this embodiment, receiving a language selection from the first party via the telecommunication device comprises pressing a telecommunication device key.

In another class of this embodiment, the telecommunication devices send information signals in a set language. The set language is a language that is known to a user of the telecommunication device.

In another class of this embodiment, a translator has a telecommunication device.

In another class of this embodiment, a translator speaks the first language and at least one additional language.

In another class of this embodiment, a translator speaks the first language and the second language.

In another class of this embodiment, a translator is employed by a translation company.

In another class of this embodiment, all translators employed by a translation company speak the second language.

In another class of this embodiment, the translator is a bilingual translator proficient in translating between a language selected by the first party and a second language.

In another class of this embodiment, the method comprises further receiving payment information from the first party or the second party.

In a subclass of this class, payment information is received by a mobile phone provider.

In another class of this embodiment, the payment information is preprogrammed.

In another class of this embodiment, the payment information is transmitted during step (a).

In another class of this embodiment, after the call is connected to a translator the telecommunication device is passed back and forth between the first party and the second party, whereby the parties take turns talking to the translator.

In another class of this embodiment, the telecommunication device is used in a speakerphone mode, whereby allowing the first party, the second party, and the translator to hear each other simultaneously and whereby eliminating the need for the communication device to be passed back and forth between the parties.

In another embodiment of the invention provided is a method for providing translation services between a call-placing party and a call-receiving party, each of the parties using a telecommunication device, the method comprising the steps of: (a) providing to the call-placing party a plurality of language selection options in the telecommunication device; (b) providing to the call-receiving party a plurality of language selection options in the telecommunication device; (c) receiving from the call-placing party a first language selection and storing the first language selection in the telecommunication device of the call-placing party; (d) receiving from the call-receiving party a second language selection and storing the second language selection in the telecommunication device of the call-receiving party; (e) transmitting the first language selection and the second language selection from the telecommunication devices to a server, and storing the first language selection and the second language selection in a database; (f) receiving a telecommunication call from the call-placing party and receiving from the call-placing party a telephone number or identity of the call-receiving party; and (g) connecting a call between the call-placing party, the call-receiving party, and a translator according to data stored in the database.

In certain class of this embodiment, the first language selection corresponds to a language spoken by the call-placing party.

In certain class of this embodiment, the second language selection corresponds to a language spoken by the call-receiving party.

In certain class of this embodiment, the database is a global database.

In a class of this embodiment, the call-placing party and the call-receiving party are about to be engaged in a telecommunication call.

In a class of this embodiment, the call-placing party speaks a first language and the call-receiving party speaks a second language.

In a subclass of this class of this embodiment, the first language and the second language are not the same.

In a class of this embodiment, the call-placing party is a client and the call-receiving party is a merchant, or vice versa.

In a class of this embodiment, the call-placing party is a person reporting an emergency and the call-receiving party is an emergency responder.

In a class of this embodiment, the call-placing party is a person reporting information about terrorist activities and the call-receiving party is a member of a counter-terrorist organization.

In another class of this embodiment, the providing to the call-placing party or the call-receiving party a plurality of language selection options comprises displaying language selections options on a screen of the telecommunication device.

In a subclass of this class of this embodiment, displaying language selections options on a screen of the telecommunication device comprises displaying: on a first screen, a world map with the contours of continents; on a second screen, a continent map with contours of individual countries, and optionally, on a third screen, languages spoken in a country.

In another class of this embodiment, displaying language selections options on a screen of the telecommunication device comprises displaying an association between a language and a telecommunication device key or a picture or a sign on the screen of the telecommunication device.

In a subclass of this class of this embodiment, the language selections options are displayed in the first language.

In a subclass of this class of this embodiment, the language selections options are displayed in the second language.

In another class of this embodiment, receiving from the call-placing party a first language selection and storing the first language selection in the telecommunication device of the call-placing party comprises pressing a portion of the screen on the telecommunication device corresponding to a language selection option or a picture or a sign on the screen of the telecommunication device.

In another class of this embodiment, receiving from the call-placing party a first language selection and storing the first language selection in the telecommunication device of the call-placing party comprises pressing a telecommunication device key.

In another class of this embodiment, receiving from the call-receiving party a second language selection and storing the second language selection in the telecommunication device of the call-receiving party comprises pressing a portion of the screen on the telecommunication device corresponding to a language selection option, or a picture, or a sign on the screen of the telecommunication device.

In another class of this embodiment, receiving from the call-receiving party a second language selection and storing the second language selection in the telecommunication device of the call-receiving party comprises pressing a telecommunication device key.

In another class of this embodiment, each translator has a telecommunication device, e.g., a mobile phone, or other mobile communicator (e.g., an iPhone).

In another class of this embodiment, a translator speaks the first language and at least one additional language.

In another class of this embodiment, a translator speaks the first language and the second language.

In another class of this embodiment, the translator is bilingual.

In another class of this embodiment, a translator is employed by a translation company.

In another class of this embodiment, all translators speak the first language.

In another class of this embodiment, all translators speak the second language.

In another class of this embodiment, the translator is a bilingual translator proficient in translating between the first language and a language selected by the first party.

In another class of this embodiment, the method comprises further receiving payment information from the first party or the second party.

In a subclass of this class, payment information is received by a mobile phone provider.

In another class of this embodiment, the payment information is preprogrammed.

In another class of this embodiment, the payment information is transmitted during step (f).

In a class of this embodiment, a call is routed to a call-receiving party after first being connected to the translator.

In a class of this embodiment, when the call-receiving party answers the call, it will already hear the translator.

In another embodiment provided is a system for providing translation services between a first party and a second party, the system comprising: (a) software and/or hardware means for providing to the first party a plurality of language selection options in the telecommunication device; (b) software and/or hardware means for receiving a language selection from the first party via the telecommunication device; and (c) software and/or hardware means for connecting a telecommunication call via the telecommunication device to a translator based on the language selection.

In another embodiment provided is a system for providing translation services between a call-placing party and a call-receiving party, each of the parties using a telecommunication device, the system comprising: (a) software and/or hardware means for providing to the call-placing party a plurality of language selection options in the telecommunication device; (b) software and/or hardware means for providing to the call-receiving party a plurality of language selection options in the telecommunication device; (c) software and/or hardware means for receiving from the call-placing party a first language selection and storing the first language selection in the telecommunication device of the call-placing party; (d) software and/or hardware means for receiving from the call-receiving party a second language selection and storing the second language selection in the telecommunication device of the call-receiving party; (e) a software or a hardware means for transmitting the first language selection and the second language selection from the telecommunication devices to a server, and storing the first language selection and the second language selection in a database; (f) a software or a hardware means for receiving a telecommunication call from the call-placing party and receiving from the call-placing party a telephone number or identity of the call-receiving party; and (g) a software or a hardware means for connecting a call between the call-placing party, the call-receiving party, and a translator according to data stored in the database.

### BRIEF DESCRIPTION OF THE DRAWINGS

The invention is described hereinbelow with reference to accompanying drawings, in which:

FIG. 1 illustrates a method for providing translation services between a first party and a second party according to one embodiment of the invention; and

FIG. 2 illustrates a method for providing translation services between a call-placing party and a call-receiving party according to another embodiment of the invention.

### DETAILED DESCRIPTION OF THE INVENTION

Definitions

The term “translation,” as used herein, refers to a communication is a second language having the same or a similar meaning as the communication in a first language. The term “translation,” as used herein, includes the normal meaning of this word as it is commonly understood by those skilled in the art.

The terms “translation services,” and “translating” as used herein, refer to providing translation for others as an occupation or business. These terms are meant to include interpreting, localizing, etc. The terms “translation services,” and “translating” as used herein, include the normal meaning of these words as it is commonly understood by those skilled in the art.

The term “party,” as used herein, refers to a person or a group of persons. A party may be a private party or a business party; that is to say that a party may be engaging in telecommunication with other parties for private purpose or for a business purpose, respectively. The term “call-placing party,” as used herein refers to a party who originally initiates a telecommunication call to a call-receiving party. The term “call-receiving party,” as used herein refers to a party who originally receives a telecommunication call from a call-placing party. The term “party,” as used herein, includes the normal meaning of this word as it is commonly understood by those skilled in the art.

The term “language selection options,” as used herein, refers to choices given to a party (a call-placing party, a call-receiving party, or any other party) to select one or more languages in which the party can communicate. For example, a call-placing party or a call-receiving party can select English, or German, or English and German as its language selection.

The term “language selection,” as used herein, refers to the choice made by a party (a call-placing party, a call-receiving party, or any other party) as to one or more languages in which the party can communicate. For example, a call-placing party or a call-receiving party can select English, or German, or English and German as its language selection.

The term “translator,” as used herein refers to a person who provides translation from one language to another. The translator may translate messages from one language into another in a spoken form (“interpreter”) or in a written form, or in a combination thereof. All modes of translation are encompasses within the term “translator”. A bilingual translator is a person who is able to communicate in at least two languages fluently. The term encompasses those translators who have membership in two different cultures. The term “translator,” as used herein, includes the normal meaning of this word as it is commonly understood by those skilled in the art.

The term “translation agency,” as used herein refers to a translator or a group of translators organized for providing translation services by means of telecommunication. The term “translation agency,” as used herein, includes the normal meaning of this word as it is commonly understood by those skilled in the art.

The term “connecting according to the language selection,” as used herein means routing the telecommunication call to a translator proficient and able to translate between at least one language selected by a call-placing party and at least one language selected by a call-receiving party. For example, if the call-placing party selects German as the language in which it can communicate and the call-receiving party selects French as the language in which it can communicated, “connecting according to the language selection” means that the parties would be connected to a translator that can translate from German into French and vice versa. As another example, if the call-placing party selects German and Spanish as the languages in which it can communicate and the call-receiving party selects French and Russian as the languages in which it can communicated, “connecting according to the language selection” means that the parties would be connected to a translator that can translate from German into French and vice versa, or from German into Russian and vice versa, or from Spanish into French and vice versa, or from Spanish into Russian, and vice versa.

The term “client,” as used herein refers to a party for which professional services are rendered, a customer or patron. The term “customer,” as used herein means one that buys goods or services. The terms “client,” and “customer” as used herein, include the normal meaning of these words as it is commonly understood by those skilled in the art.

The term “merchant,” as used herein refers to a person or a group of people who run a business, whether or not for profit, and is meant to encompass those persons whose occupation is the purchase and/or sale of goods and/or services for profit. The term “merchant,” as used herein, includes the normal meaning of this word as it is commonly understood by those skilled in the art.

The term “telephone keypad,” as used herein, refers to a keypad that appears on a “touch tone” telephone. It was standardized when the dual-tone multi-frequency (DTMF) system was introduced in the 1960s. The contemporary keypad is laid out in a 3×4 grid of “telephone keys”. When used to dial a telephone number, pressing a single key will produce a pitch consisting of two simultaneous pure tone sinusoidal frequencies. The row in which the key appears determines the low frequency, and the column determines the high frequency. For example, pressing the ‘1’ key will result in a sound composed of both a 697 and a 1209 hertz (Hz) tone. The term “telecommunication device keypad,” as used herein, refers to a keypad that appears on a telecommunication device. A telecommunication device keypad can be physical or virtual, i.e., it can be made of physical buttons or of buttons that appear on the screen (e.g., a touch screen) of a telecommunication device. A telecommunication device keypad in general includes a telephone keypad.

The term “associating each language with one or more telecommunication device keys,” as used herein refers to providing a party (e.g., a call-placing party, a call-receiving party, or any other party) a way to select one or more languages in which the party can communicate by pressing one or more telephone keys. For example, in order to select English, the party is asked to press the #4 key, or the #4 key followed by the #6 key. A party may also be asked to spell the name of the language to be selected using the key pad. A specified letter mapping standard may be used to map letters to telephone keys. For example, the international standard ITU E.161/ISO 9995-8 is chosen.

The term “preprogrammed,” as used herein refers programming in advance, e.g., of the actual call. For example, payment information may be in advance programmed into the system (on the side of the call-placing party, on the side of the call-receiving party, or both, and/or on the side of the translation agency) so that it may be automatically transmitted to pay for translation services when translation services are requested. Preprogrammed payment information may include, e.g., customer number and pin code or credit card information.

The term “telecommunication,” as used herein, refers to the science and technology of communication at a distance by electric or electronic transmission of impulses, as, e.g., by telegraph, cable, telephone, mobile telephone, walkie-talkie, radio, or television. The term “telecommunication,” as used herein, includes the normal meaning of this word as it is commonly understood by those skilled in the art.

The term “telecommunication call,” as used herein, refers to a communication or connection between two or more parties at a distance by electric or electronic transmission of impulses, as, e.g., by telegraph, cable, telephone, mobile telephone, walkie-talkie, radio, or television.

The term “telecommunication device,” as used herein, refers to anything man-made for communication at a distance by electric or electronic transmission of impulses, as, e.g., by telegraph, cable, telephone, mobile telephone, walkie-talkie, radio, or television. A telecommunication device includes, but is not limited to, a mobile phone, a personal digital assistant (PDA), and particularly, iPhone by Apple Inc.

The term “software and/or hardware means for providing a plurality of language selection options in the telecommunication device,” as used herein, refers to a device, or anything else man-made, for providing choices to a party (e.g., a call-placing party, a call-receiving party, or any other party) to select one or more languages in which the party can communicate. Means for providing a plurality of language selection options is, for example, a voice announcement, pre-recorded or otherwise, played to the party via a telecommunication device, incl. a telephone, or a text message, or a pictorial message displayed to the party via, e.g., a telecommunication device, incl. a mobile phone.

The term “software and/or hardware means for receiving a language selection via the telecommunication device,” as used herein, refers to a device, or anything else man-made, for receiving the choice made by a party (a call-placing and/or a call-receiving party) as to one or more languages in which the party can communicate. Means for receiving a language selection comprises, for example, a converter of dual-tone multi frequency signal to a digital number.

The term “software and/or hardware means for connecting a telecommunication call via the telecommunication device to a translator based on the language selection,” as used herein, refers to a device, or anything else man-made, for teleconferencing a call-placing party, a call-receiving party, and a translator. Means for connecting with a translator is, for example, a telephone exchange programmed to teleconference teleconferencing a call-placing party, a call-receiving party, and a translator based on the language selection.

The term “programmable with information,” as used herein, with respect to a telecommunication device refers to the ability to input into the memory of the device a list of languages spoken by a party using the device. For example, a call-placing party programs its mobile phone by inputting the languages English, German, and Russian, as the languages spoken by the call-placing party.

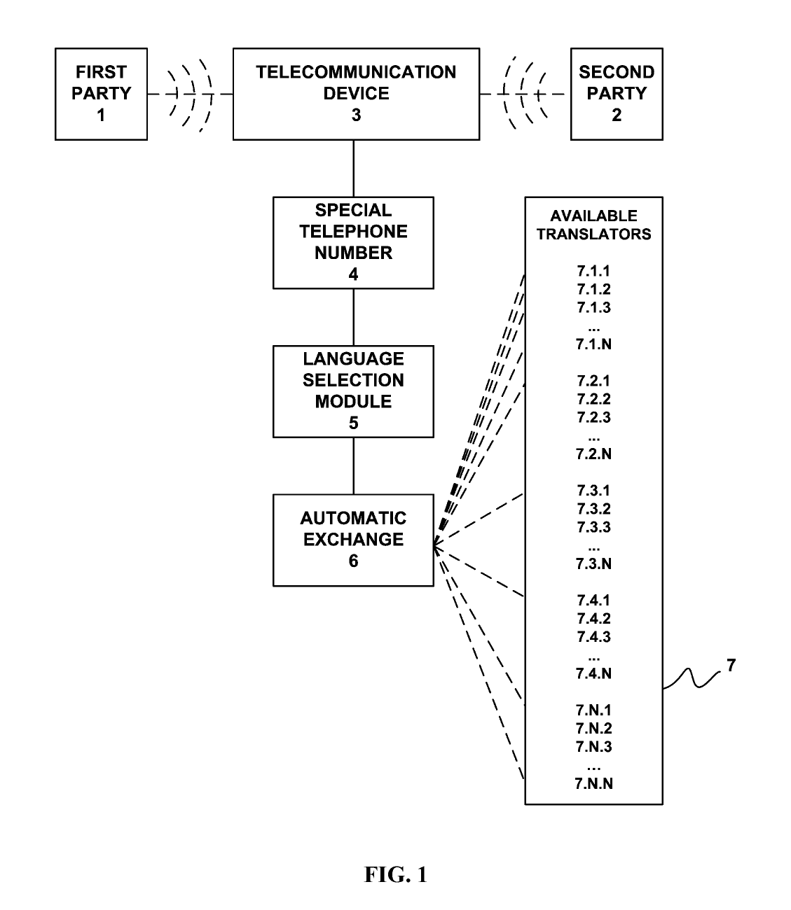

With reference to FIG. 1, a method is provided for providing translation services between a first party 1 and a second party 2, using a telecommunication device 3. In more detail, when two parties come together and wish to communicate with one another yet do not speak a common language, it is often desirable to employ a translator 7 able to translate between the two parties, i.e., a translator able to speak and translate between a first language spoken by the first party and a second language spoken by the second party. Frequently, a need for a quick access to a translator arises when the first party travels to a foreign country and cannot communicate in a language spoken in that country. This invention makes it possible to quickly and efficiently provide translation services to the first party.

Further with reference to FIG. 1, a first party, e.g. the party who owns the telecommunication device 3, in order to obtain translation services dials using the telecommunication device 3 a generally available special telephone number 4. This special telephone number may be provided in a form similar to those of emergency responders (911), or may be a regular telephone number. After the call is connected, the party is given choices by the language selection module 5 to select a language spoken by the first party.

Generally, it is assumed that the first party is a party traveling to an area where a language other than that the first party speaks is widely spoken, and that the second party speaks a language common to the area where the parties are present and/or where the special telephone number 4 is provided. This is to say that the special telephone number 4 is provided for parties who speak a certain language and that the language selection module 5 provides language selection in multiple languages. For example, when the language service is offered in the United States, it is assumed that the second party speaks English and that the first party speaks a language other than English. (But this could be set differently by convention.) Thus, when the special telephone number 4 offered in a foreign country is dialed by the first party, the first party 1 is asked in a variety of languages to select a language that the first party 1 speaks.

However, if the first party is present in an area where the special telephone number 4 is not available or if the second party does not speak a language common to the area, the first party can place a telecommunication call to the party's own home area to call a special telephone number 4, i.e., a special telephone number 4 that features a language selection module 5 operating in a language spoken by the call-placing party, and transfer the telecommunication device 3 to the second party, who then chooses his or her language by using the language selection module.

The language selection module 5 provides the language selection options either as a spoken announcement, (e.g., For English, press one; Para Espanol, Oprima Numero Dos, fiur Deutsch, bitte driicken Sie die drei, etc.), by entering a combination of telephone keys known from TV commercials, brochures, etc., or as a list of languages that is displayed on the screen of the telecommunication device (touch screen selection). In the latter case, the list of languages can be displayed in stages. For example, the first screen may show a map of the world with contours of continents. Pressing on one of the continents, would open a second screen that would display all individual countries of that continent. Pressing on one of the countries would automatically select a language spoken in that country for single-language countries or open a third screen with selections of languages commonly spoken in that country.

The language selection options are automatically provided and constitute a collection of messages in various foreign languages communicating that one can connect to a given translator for a given price when selecting a specified combination of keys.

All selections may be entered manually using telecommunication device keys or may be made automatically by the translation module (hardware or software based) built into the stationary or mobile phone of the party making the selections. When telecommunication device keys are being used (tone dial selection), it should be assured that selections are entered using the same international standard. For example, the most widely used standard for letter mapping is international standard ITU E.161/ISO 9995-8, wherein A, B, and C are assigned to the number 2 key; D, E, and F are assigned to the number 3 key; G, H, and I are assigned to the number 4 key, and so on.

Once a language selection is received, an automatic exchange 6, which is a telecommunication device enabling forwarding of telecommunication calls, forwards the call to a first available translator 7.N.N of the language selected using the language selection module 5. Specifically, when the special telephone number is established in an English speaking area, a plurality of translators may be employed by a translation company 7 who are able to translate, e.g., from English to Spanish 7.1.1, 7.1.2, 7.1.3, . . . , 7.1.N, from English to Russian 7.2.1, 7.2.2, 7.2.3, . . . , 7.2.N, from English to German 7.3.1, 7.3.2, 7.3.3, . . . , 7.3.N, from English to Polish 7.4.1, 7.4.2, 7.4.3, . . . , 7.4.N, and from English to other language 7.N.1, 7.N.2, 7.N.3, . . . , 7.N.N.

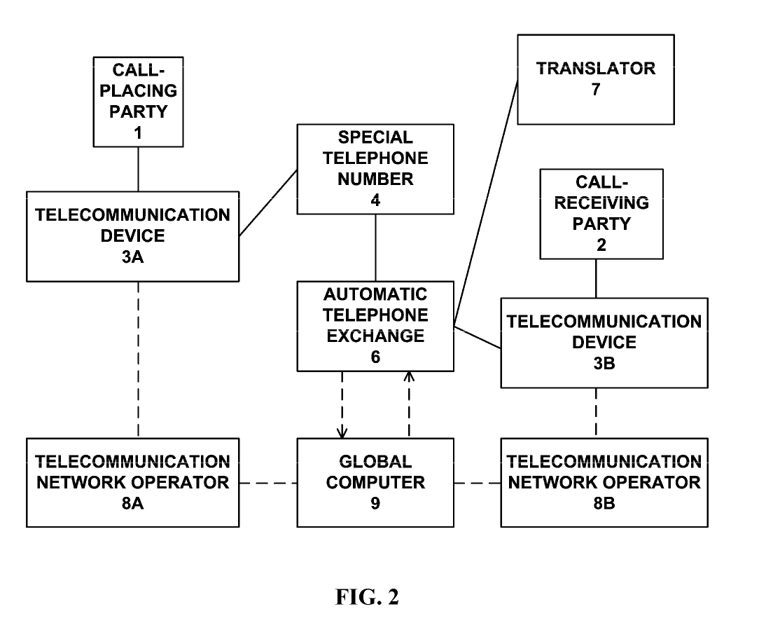

With reference to FIG. 2, another method is provided for providing translation services between a call-placing party 1 and a call-receiving party 2 when each of the parties has its own telecommunication device, i.e., when the call-placing party 1 uses a telecommunication device 3A to communicate, and the call-receiving party uses a telecommunication device 3B to communicate.

The call-placing party preprograms the telecommunication device 3A with a first language selection that the call-placing party is able to communicate in. The first language selection is a selection of a language spoken by the call-placing party and used by the call-placing party to operate the telecommunication device. The first language selection is stored in the first telecommunication device 3A. This is to say that the language selection is set in the menu of the telecommunication device 3A to operate the device regardless of whether or not the call-placing party will ever use the translation system. During the first connection after the telecommunication device has been put into operation or the language selection has been changed, the telecommunication device 3A sends an information signal with the first language selection to a global computer 9 via telecommunication network operator 8A. The first language selection is then stored in a global database in association with an identifier for the call-placing party 1. The first language selection can also be additionally stored in a separate database of the telecommunication network operator 8A. This step also occurs regardless of whether or not the call-placing party will ever use the translation system.

Similarly, the call-receiving party preprograms the telecommunication device 3B with a second language selection that the call-receiving party is able to communicate in. The second language selection is a selection of a language spoken by the call-receiving party and used by the call-receiving party to operate the telecommunication device. The second language selection is stored in the second telecommunication device 3B. This is to say that the language selection is set in the menu of the telecommunication device 3B to operate the device regardless of whether or not the call-receiving party will ever use the translation system. During the first connection after the telecommunication device has been put into operation or the language selection has been changed, the telecommunication device 3B sends an information signal with the second language selection to a global computer 9 via telecommunication network operator 8B. The second language selection is then stored in a global database in association with an identifier for the call-receiving party 2. The second language selection can also be additionally stored in a separate database of the telecommunication network operator 8B. This step also occurs regardless of whether or not the call-receiving party will ever use the translation system.

Illustrating further with reference to FIG. 2, when the call-placing party 1 wishes to communicate with the call receiving party 2, yet the parties do not speak a common language, it is often desirable to employ a translator 7 able to translate between the two parties, i.e., a translator able to speak and translate between a first language spoken by the call-placing party and a second language spoken by the call-receiving party. This invention makes it possible to quickly and efficiently provide translation services to the parties.

Further with reference to FIG. 2, in order to obtain translation services, the call-placing party dials using the telecommunication device 3A a generally available special telephone number 4 (“GSTPC number”). This special telephone number may be provided in a form similar to those of emergency responders (911), or may be a regular telephone number. After the call is connected, the call-placing party enters a phone number of the call-receiving party or otherwise identifies the identity of the call-receiving party. Alternatively, the call-placing party dials the special telephone number 4 and the phone number of the call-receiving party simultaneously. Particularly, the call-placing party may dial a prefix associated with the translation service (a so called “GSTPC prefix”) and the phone number of the call-receiving party in one string before pressing the “SEND” button.

When the call is received the automatic telephone exchange 6 automatically identifies the number of the call-placing party 1. Using the identity of the call-placing party and the identity of the call receiving party, the automatic exchange 6 looks up in the global database a language pair spoken by the call-placing party and the call-receiving party, and connects a three-way call between the call-placing party, the call-receiving party, and a first available translator 7.N.N able to translate between the first language spoken by the call-placing party and the second language spoken by the call-receiving party. In particular, the automatic exchange 6 accesses the global database residing on a global computer 9 and retrieves the language selection options of the call-placing party and the call-receiving party that the parties have deposited earlier into the database. In this embodiment, unlike in the embodiment utilizing one telecommunication device only, not all translators need to speak the same local language. Rather each translator is able to translate in a certain language pair, e.g., from Chinese to Japanese, from Czech to French, from Bantu to Mongolian, etc.

The methods of this invention are particularly applicable to counter-terrorism. Specifically, the ability to rapidly select or preprogram into telecommunication device information about the languages spoken by the owner of the telecommunication device speeds up response to counter terrorism. For example, when the call-placing party is a person reporting an emergency and the call-receiving party is an emergency responder, information about whether or not translation is needed is immediately disseminated when the call is placed and the call can be quickly routed to appropriate operator, or a translator can teleconferenced in. Since terrorism is a global phenomenon, it is important to enable emergency responders and counter-terrorism personnel with the quickest possibility to understand report received from persons having information useful for capturing terrorists.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

1. A method for providing translation services between a first party and a second party, the parties using a single telecommunication device, the method comprising the steps of:
(a) providing a plurality of language selection options in said telecommunication device;
(b) receiving a language selection via said telecommunication device; and
(c) connecting a telecommunication call via said single telecommunication device to a translator based on said language selection;
wherein said language selection options are provided in a menu of said single telecommunication device to operate said device, and said language selection is used to operate said telecommunication device regardless of whether the parties use the translation services.

2. The method of claim 1, wherein said first party and said second party are physically present in the same place.

3. The method of claim 2, wherein said first party speaks a first language and said second party speaks a second language.

4. The method of claim 3, wherein step (a) comprises providing spoken instructions associating language selections with one or more telecommunication device keys.

5. The method of claim 3, wherein step (a) comprises displaying the language selections options on a screen of the telecommunication device.

6. The method of claim 5, wherein the language selections options are displayed in a plurality of languages or in the first language.

7. The method of claim 6, wherein step (b) comprises pressing a portion of the screen on the telecommunication device corresponding to the language selection option, or a picture, or a sign on the screen of the telecommunication device.

8. The method of claim 4, wherein step (b) comprises pressing a telecommunication device key.

9. The method of claim 8, wherein said translator speaks said first language and said second language.

10. The method of claim 9, wherein said first party is a person reporting an emergency or information about terrorist activities, and said second party is an emergency responder or a member of a counter-terrorist organization.

11. A method for providing translation services between a call-placing party and a call-receiving party, said call-placing party having a first telecommunication device and said call-receiving party having a second telecommunication device, the method comprising the steps of:
(a) providing to said call-placing party a plurality of language selection options in said first telecommunication device;
(b) providing to said call-receiving party a plurality of language selection options in said second telecommunication device;
(c) receiving from said call-placing party a first language selection and storing said first language selection in said first telecommunication device;
(d) receiving from said call-receiving party a second language selection and storing said second language selection in said second telecommunication device;
(e) transmitting said first language selection and said second language selection to a server, and storing said first language selection and said second language selection in a database;
(f) receiving a telecommunication call from said call-placing party and receiving from said call-placing party a telephone number of said call-receiving party or information otherwise identifying said call-receiving party; and
(g) connecting a telecommunication call between said call-placing party, said call-receiving party, and a translator according to data stored in said database;
wherein
said language selection options in said first telecommunication device are provided in a menu of said first telecommunication device to operate said first telecommunication device, and said first language selection received from said call-placing party is used to operate said first telecommunication device regardless of whether the call-placing party uses the translation services; and
said language selection options in said second telecommunication device are provided in a menu of said second telecommunication device to operate said second telecommunication device, and said second language selection received from said call-receiving party is used to operate said second telecommunication device regardless of whether the call-receiving party uses the translation services.

12. The method of claim 11, wherein said first language selection corresponds to a language spoken by said call-placing party.

13. The method of claim 12, wherein said second language selection corresponds to a language spoken by said call-receiving party.

14. The method of claim 13, wherein in step (g) said telecommunication call is routed to said call-receiving party after first being connected to said translator.

15. The method of claim 14, wherein step (a) comprises displaying language selections options on a screen of said first telecommunication device in said first language; and step (b) comprises displaying language selections options on a screen of said second telecommunication device in said second language.

16. The method of claim 15, wherein step (c) and step (d) each comprise pressing a portion of the screen on the telecommunication device corresponding to a language selection option, or a picture, or a sign on the screen of the telecommunication device.

17. The method of claim 16, wherein said database is a global database.

18. The method of claim 17, wherein said call-placing party is a client and said call-receiving party is a merchant.

19. The method of claim 17, wherein said call-placing party is a person reporting an emergency, or a person reporting information about terrorist activities; and said call-receiving party is an emergency responder, or a member of a counter-terrorist organization.

20. The method of claim 17, wherein said translator speaks at least said first language and said second language.
